(19) United States
(12) Patent Application Publication
(10) Pub. No.: US 2009/0106099 A1
(43) Pub. Date: Apr. 23, 2009

(54) PERSONAL TARGETED ADVERTISING

(75) Inventors: Jyh-Herng Chow, San Jose, CA (US); Jerry Xian Hui Ye, Oakland, CA (US); Yi-Kai Tsai, Hsinchu (TW)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 11/877,227

(22) Filed: Oct. 23, 2007

(51) Int. Cl. G06Q 30/00; G06Q 40/00

(52) U.S. Cl. 705/14; 705/40

(57) ABSTRACT

A method for providing personal targeted advertising includes receiving, from a user, a submission of a search-ad comprising a personal targeted advertisement associated with at least one rare search term; storing the personal targeted advertisement; detecting a query for the at least one rare search term; and displaying the personal targeted advertisement in response to detecting the query for the at least one rare search term.

### BACKGROUND

1. Technical Field

The disclosed embodiments relate to a system and method for providing personal targeted advertising, which includes use of vanity ads, through any number of avenues, including search-ads, content match ads, and display ads.

2. Related Art

Internet advertising is a multi-billion dollar industry and is growing at double digits rates in recent years. It is also the major revenue source for internet companies, such as Yahoo!® or Google®, which provide advertising networks that connect advertisers, publishers, and Internet users. Common business models for Internet advertising include click-based models and impression-based models. In click-based advertising, revenue is generated for the advertising network company when someone clicks on the advertisement (“ad) (cost-per-click (CPC)) or click on the ad which leads to some desired action (cost-per-action (CPA)) such as purchase order or phone call. In impression-based advertising, advertisers buy a specified number of impressions of their ads on popular sites. An impression is the count of a delivered basic advertising unit from an ad distribution point, such as an ad server. Impressions are how most Web advertising is sold and the cost is quoted in terms of the cost per thousand impressions (CPM).

Two typical click-based advertising products are search-ads (referred to sometimes as sponsored search ads) and content match ads. In search-ads, given a user search query, the search engine companies display relevant ads from their ads inventory along side the search results, which when clicked lead to the advertiser Web page associated with the displayed ad. Content match ads, in contrast, relate to a given Web page, wherein ads are selected based on their relevance to the content of the page. In this way, a matching engine thinks for a browsing user on a particular Web page and attempts to make an educated guess as to other advertiser websites in which the browsing user might be interested. In search ads, for popular search queries, the advertisers compete for better ad display positions by paying higher bid prices. However, rare queries usually find no relevant ads in the inventory. Likewise, rare queries are rarely entered into a search engine, providing advertisers little incentive to bid on them. Thus, rare queries are currently not monetized well, and the precious real estate of the search result pages is wasted. This is the observation of under-monetized rare queries.

### SUMMARY

By way of introduction, the embodiments described below are drawn to a system and method for providing personal targeted advertising, which includes use of vanity ads, through any number of avenues, including search-ads, content match ads, and display ads.

In a first aspect, a method is disclosed for providing personal targeted advertising, the method including receiving, from a user, a submission of a search-ad including a personal targeted advertisement associated with at least one rare search term; storing the personal targeted advertisement; detecting a query for the at least one rare search term; and displaying the personal targeted advertisement in response to detection of the query for the at least one rare search term.

In a second aspect, a method is disclosed for providing personal targeted advertising, the method including receiving from a self-serving application of a vanity ads provider a submission of a personal targeted advertisement that a user desires at least one other person to see in response to at least one specific search term when queried of a search engine; submitting the personal targeted advertisement to an advertising network of the search engine through a sponsored search account of the vanity ads provider; and paying, on behalf of the user, any advertising fees for display of the personal targeted advertisement when queried for by the at least one other person.

In a third aspect, a method is disclosed for providing personal targeted advertising, the method including receiving, from a first user, a submission of a personal targeted advertisement together with a corresponding predetermined Web page to be displayed to a second user; storing the personal targeted advertisement for later display on the pre-determined Web page; detecting the second user browsing to the predetermined Web page; and displaying the personal targeted advertisement on the predetermined Web page for viewing by the second user.

In a fourth aspect, a system for serving personal targeted advertising includes an ad server having a processor, a memory, and a search results generator to serve a personal targeted advertisement in response to a user query on a rare search term, wherein the personal targeted advertisement is submitted by a customer. A vanity ads database is coupled with the ad server to store the personal targeted advertisement in relation to the rare search term. A Web pages database is coupled with the ad server to store Web pages to be served with the personal targeted ad. The processor tracks at least a number of times the rare search term is searched for so that an account of the customer may be decremented according to the cost of each search event. A vanity ads provider may be provided in network communication with a vanity ads client to receive therefrom the personal targeted advertisement together with at least one of a corresponding Web page link and a corresponding rare search term. The vanity ads provider is coupled with the ad server to submit thereto the personal targeted advertisement and corresponding at least one of the Web page link and the rare search term.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like-referenced numerals designate corresponding parts throughout the different views.

FIG. 1 is a diagram of an exemplary system for generating personal targeted advertising, optionally through use of a vanity ads provider.

FIG. 2 is a diagram depicting simplified Web browser screens showing operation of the system of FIG. 1.

FIG. 3 depicts an exemplary display of a personal targeted ad in response to a search query, as set up by a User A in Table 1.

FIG. 4 is a diagram depicting simplified Web browser screens showing operation of the system of FIG. 1.

FIG. 5 depicts an exemplary display of a personal targeted display ad in response to a specific user browsing to a predetermined website as discussed with reference to FIG. 4.

FIG. 6 is a flow chart showing exemplary operation of the system depicted in FIG. 1 and FIG. 2.

FIG. 7 is a flow chart showing exemplary operation of the system depicted in FIG. 1 and FIG. 4.

### DETAILED DESCRIPTION

In the following description, numerous specific details of programming, software modules, user selections, network transactions, database queries, database structures, etc., are provided for a thorough understanding of various embodiments of the systems and methods disclosed herein. However, the disclosed system and methods can be practiced with other methods, components, materials, etc., or can be practiced without one or more of the specific details. In some cases, well-known structures, materials, or operations are not shown or described in detail. Furthermore, the described features, structures, or characteristics may be combined in any suitable manner in one or more embodiments. The components of the embodiments as generally described and illustrated in the Figures herein could be arranged and designed in a wide variety of different configurations.

The order of the steps or actions of the methods described in connection with the disclosed embodiments may be changed as would be apparent to those skilled in the art. Thus, any order appearing in the Figures, such as in flow charts, or in the Detailed Description is for illustrative purposes only and is not meant to imply a required order.

Several aspects of the embodiments described are illustrated as software modules or components. As used herein, a software module or component may include any type of computer instruction or computer executable code located within a memory device and/or transmitted as electronic signals over a system bus or wired or wireless network. A software module may, for instance, include one or more physical or logical blocks of computer instructions, which may be organized as a routine, program, object, component, data structure, etc. that performs one or more tasks or implements particular abstract data types.

In certain embodiments, a particular software module may include disparate instructions stored in different locations of a memory device, which together implement the described functionality of the module. Indeed, a module may include a single instruction or many instructions, and it may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices.

As discussed, rare queries are currently not monetized well, and precious real estate of search result pages is wasted. On the other hand, people are willing to spend a significant amount of effort and money to surprise and/or impress someone they love or have an interest in by a simple message or note. Business venues have been created for such personal advertising, including: aerial advertising that stream banners behind a flying plane; banners (electronic or draped) displayed during an event, such as at sports game; and sides of buildings or on billboards. These types of personal ads are sometimes referred to as vanity ads.

The observation of under-monetized rare queries and the demand for vanity ads lead to an unfulfilled niche market for which a new business model is available while using existing advertising platforms. More precisely, a market exits for monetizing online ad space for those wishing to pay for personal targeted ads, variably referred to herein as vanity ads. For example, for search ads business, this disclosure explains enabling an advertising network or company to sell rare queries to individuals or resellers of such ads while keeping an existing search ads business intact. Although motivated by monetizing rare search queries, this disclosure includes broader applications for use in any online ad serving environment, including search-ads (click-based or impression-based as discussed above), content match ads, and display or banner ads.

As used herein, a rare search term is a word, a group of words or a phrase subjectively or objectively rarely utilized or lacking any meaning, or any agreed upon meaning, in the common vernacular at a particular time, but which may have meaning to the user, or demographic or cultural category to which the user belongs, and which may be used more frequently or develop meaning in the common vernacular later in time. Examples of rare search terms may include names of people, obscure or uncommon words or phrases such as “who is the most naïve person you know,” and nonsensical or made-up words that may not even exist in a typical non-technical dictionary. The possibilities would seem endless, as many different words or phrases will have special meaning to certain individuals.

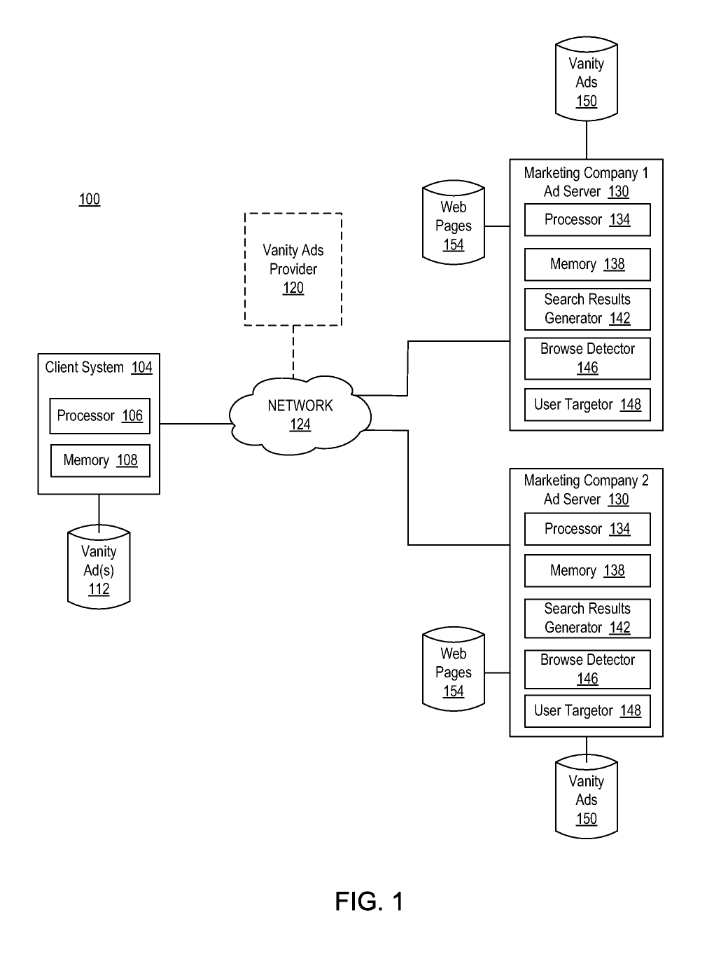

FIG. 1 is a diagram of an exemplary system 100 for generating personal targeted advertising. The system 100 includes a plurality of customer client computer systems 104 (hereinafter client system 104), which includes at least a processor 106 and a memory 108 for necessary computer processing. A vanity ads database 112 is also provided for storing the various vanity ads of the user of the client system 104. A vanity ads provider 120 is an optional part of the system 100 that may play the part of a third party reseller that provides a way for users to easily purchase vanity ad space on the Internet through the vanity ads provider 120.

A customer through the client system 104, optionally by way of the vanity ads provider 120, purchases vanity ad search terms and/or display advertising space over a network 124 from a marketing company ad server 130, which may be owned by search engines such as Yahoo!®, Google®, or by digital marketing companies such as DoubleClick®. The network 124 may include the Internet and may also include a local area network (LAN), a wide area network (WAN), an Intranet, and other forms or parts of a network and various ways to connect thereto. The marketing company ad servers 130 are indicated in plural as company 1 and company 2 herein, but one of skill in the art will appreciate that any number of marketing companies may be included in the system.

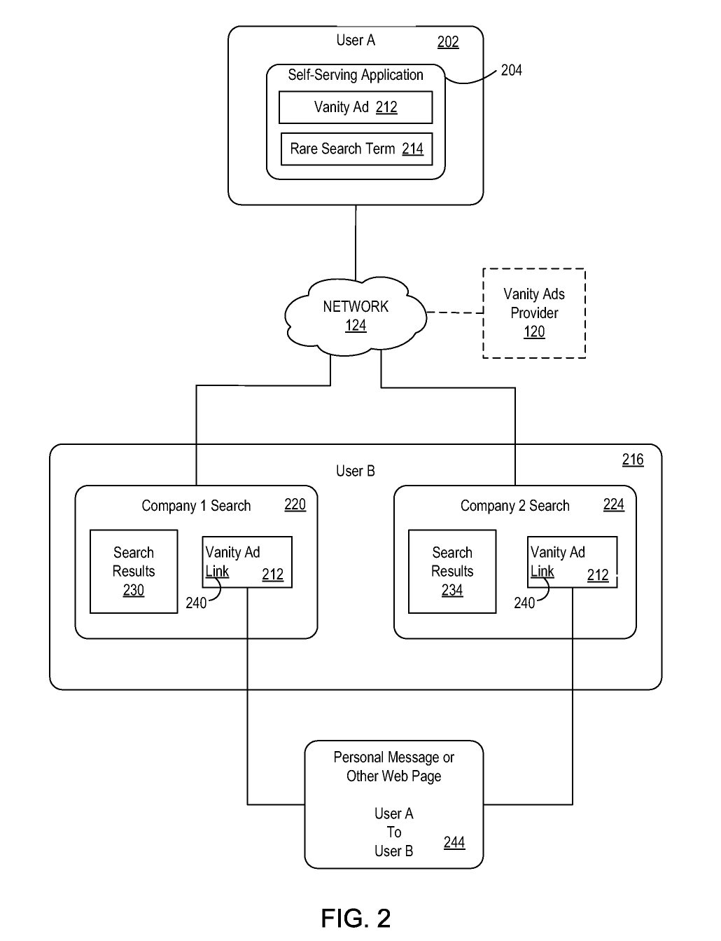

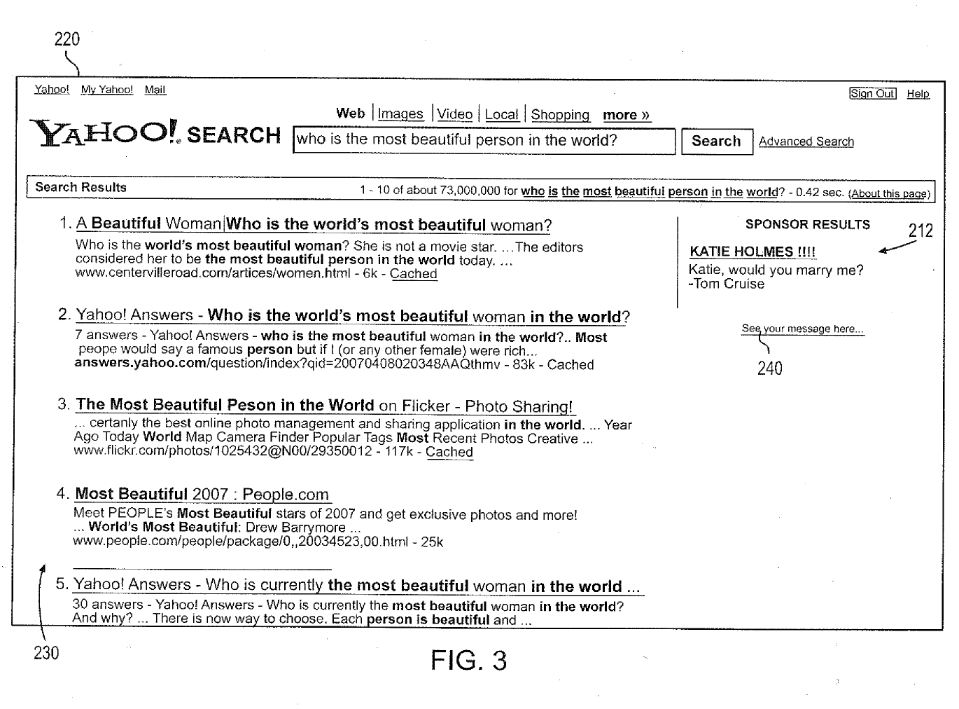

The vanity ads provider 120 may include a third party application builder such as a social networking website that has already established an advertising account with search marketing and ad companies such as listed above. As such, the vanity ads provider 120 may provide a streamlined self-serving application (see FIGS. 2 and 3) to users that want to build various types of vanity ads for placement on a Web page served by at least one of the marketing company ad servers 130.

As most basic Internet users do not seek to do commercial advertising, establishing and maintaining an account on a marketing company ad server 130 is not realistic for such users. Additional fees or a minimal amount of advertising may be required for such advertising accounts. Currently in the Yahoo! Search Marketing program, an advertiser first needs to open a sponsored search account and set up the account with contact and billing information, including an initial deposit and credit card information. This initial set up process can be unnecessarily complicated and/or expensive for ordinary casual users to buy vanity ads. A vanity ads provider 120 can sign up numerous vanity ad users and thus justify the expense and complexity of interacting with marketing company ad servers 130.

The ad servers 130 shown in FIG. 1 may each include a processor 134, a memory 138, a search results generator 142, a browse detector 146, and a user targetor 148. The search results generator 142, the browse detector 146, and the user targetor 148 may be included in the processor 134 or as a part of the software being executed by the processor 134 with help from the memory 138. The ad servers 130 may each also include a vanity ads database 150 and a Web pages database 154, which may be logically and/or physically the same database or exist in disparate locations across the network 124 so long as they are coupled with respective ad servers 130. Herein, the phrase “coupled with” is defined to mean directly connected to or indirectly connected through one or more intermediate components. Such intermediate components may include both hardware and software based components.

The Web pages database 154 includes those Web pages that are to be served with the vanity ads stored in the vanity ads database 150, and therefore, a Web page may be stored relative to a vanity ad to be served thereto at least in the case of serving a vanity display ad, which will be discussed in detail later. Note also that search-related vanity ads to be displayed in response to a search query may be displayed in conjunction with a results list that pulls Web pages from disparate regions of the Internet. Therefore, the Web pages stored in the database 154 should be understood to extend to various storage locations throughout the Internet, including various Web servers of other search engine or marketing companies.

The owner of the a Web page (also referred to as a publisher) may also need to add or insert a piece of code (e.g., a javascript) into the Web page, which when displayed to an Internet user, will issue a request (or call) to the ad server 130 to display the served ad on the Web page. Accordingly, all that may need be stored in the Web pages database 154 are the uniform resource locator (URLs) to the Web pages so that the vanity ads can be served to the proper location (e.g., in a location of a Web page located through an external Web server) once a call for the Web page is made.

The search results generator 142 reacts to a search query submitted by an Internet searching user, and produces a search results list to be displayed in a Web browser of the user for selection (see FIG. 2). The search results list usually includes short descriptions along with links to corresponding advertiser Web pages (or URLs thereto) stored in the Web pages database 154. The search results generator 142 may attempt to list the search results so that the most relevant search results are listed first, which may include a number of sponsored listings of those who have bid highest on the search term(s) in a pay-per-click system. Under the current system 100, the search results generator 142 will now also display a personal targeted (or vanity) ad in response to a query for a rare search term (or terms) (FIG. 2). One of the advantages of serving search-related vanity ads is that it may be executed through existing search ads systems.

In alternative embodiments where the rare search term(s) become more sought after due to the advent of the system 100, the search results may include a traditional list of short advertisements and links to a full, detailed vanity ad where the list is ranked according to relevancy or by some other methodology, such as by creativity. A bidding system may also be established similar to the pay-per-click system described above so that competing vanity ad users may bid for the highest listed positions for more popular rare search terms. A rare search term may be considered “popular” after least two vanity ads customers submit to the ad server 130 for purchase thereof.

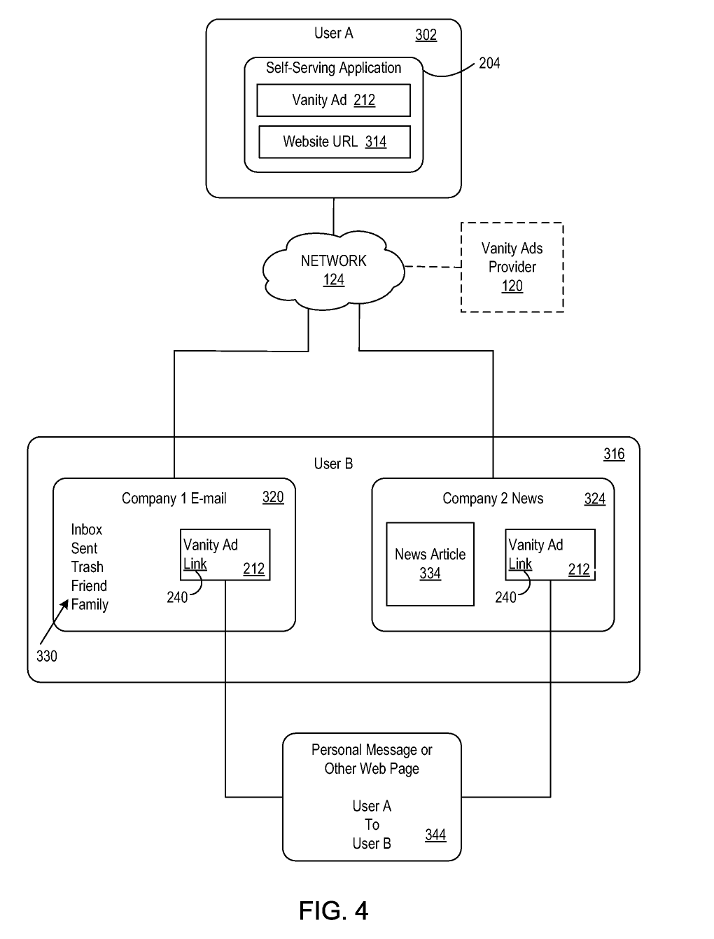

The browse detector 146 may perform many functions, one of which is to detect when specific users access predetermined Web pages where display vanity ads are to be served. Sometimes this may be easy as detecting when the specific user logs into an account that the user owns, which leads the user to the targeted predetermined Web page, e.g., an e-mail account home page, a social networking account homepage, etc. With other Web pages that are publicly available, e.g. a news website, the browse detector 146 detects when the specific user accesses the news website, such as through the use of cookies or Internet Protocol (IP) resolution of the user's computer. The user targetor 148 performs a similar function, but works to serve the ad to Web pages that target a group of users having defined profiles. The browse detectors 146 and the user targetor 148 will be discussed in greater detail with reference to FIG. 4.

The processor 134 works in conjunction with the search results generator 142, the browse detector 146, and the user targetor 148 to generally track the number of times a rare search term is searched for, and a number of impressions and/or clicks with regards to any given vanity ad. For each event, such as a search, an impression, or a click, for which a cost is associated, the processor 134 decrements an account balance of a submitting customer or otherwise accrues an amount to later charge the submitting customer. Recall that the submitting customer may be the vanity ads provider 120 which will be charged instead of the customer for the vanity ads exposure. Such vanity ads providers 120 may have their own charge schemes for particular vanity ads submitted on behalf of such customers, or may directly pass on the costs along with a surcharge to the customers. The ways in which the vanity ads may be monetized are similar to those for commercial ads and this disclosure is meant to encompass any monetization known or contemplated in the art of online advertising.

FIG. 2 is a diagram of the system 100 of FIG. 1, depicting simplified Web browser screens based on the functioning of the system 100 to provide a targeted personal (or vanity) ad in response to a search query. FIG. 3 is a screen shot depicting an exemplary display of a vanity ad in response to a search query for a rare search term as set up in Table 1 below. A computer screen 202 of User A shows a self-serving application 204 that User A may use to submit vanity ads. A vanity ad 212 is one of those stored in the vanity ads database 112 or in other memory 108 or storage on the client system 104. The vanity ad 212 may be submitted, along with a corresponding rare search term 214, by User A through the vanity ads provider 120 to at least one of the ad servers 130 of the marketing companies. The self-serving application 204 may be provided by the vanity ads provider 120 so that it is understandable and user friendly for User A to submit the vanity ad 212 and the rare search term 214. To provide a user-accessible interface, the self-serving application 204 may be template-based.

As an example, a user such as Tom Cruise (User A) may enter the following information to create a vanity ad using the self-serving application 204.

TABLE 1

| input field | value |
|---|---|
| target location region | US |
| search keywords | “who is the most beautiful person in the world?” |
| pricing & budget | daily limit: $10, maximum bid = $0.1 |
| create ads | title = “Katie Holmes !!!!”, |
| (title, description, url) | description = “Katie, would you marry me? - |
| | Tom Cruise”, url = “http://youtube.com/ |
| | somevideo” |

As discussed with reference to FIG. 1, the ad server 130 then stores the submitted vanity ad 212 in the vanity ads database 150. The vanity ad 212 may be stored according to whether it is to be served as a search-ad or a display ad, which in some cases may be both. FIG. 2 depicts the instance of returning search results in response to a search query. A computer screen 216 of User B includes two browser windows 220, 224, one each for viewing search results from two different search engines. Of course, viewing both screens in separate browsers is exemplary only to depict that the vanity ad 212 may be submitted to one or both of the marketing companies' ad servers 130 for potential display through more than one search engine.

When User B goes to the company 1 search browser 220 and types in the rare search term 214, a list of search results 230 is displayed along with the vanity ad 212. Likewise, when User B goes to the company 2 search browser 224 and types in the rare search term 214, a list of search results 234 is displayed along with the vanity ad 212. It is also conceivable that the vanity ad 212 displayed through each of the browsers 220, 224 may vary based on options offered when User A submits the vanity ad 212 to marketing company ad servers 130 of respective companies 1 and 2. Following with the example from Table 1, as shown in FIG. 3, when Katie Holmes (User B) goes to search for the phrase “who is the most beautiful person in the world?,” a display ad will also be displayed in the sponsored results reading “Katie Holmes!!! Katie, would you marry me?—Tom Cruise.”

When User B clicks on a hyperlink 240 which may be made available with the vanity ad 212, the browser 220, 224 is redirected to another Web page 244 containing a more detailed personal message or some other information of interest that User A wants to communicate to User B. Alternatively, a pop-up window or other browser window may appear to display the more detailed personal message or the other Web page 244 location. Following with the example from Table 1, a hyperlink 240 may be provided somewhere in conjunction with the ad that, when selected, leads Katie Holmes to the youtube.com website to watch “somevideo,” which may be a personal recorded invitation to marry her.

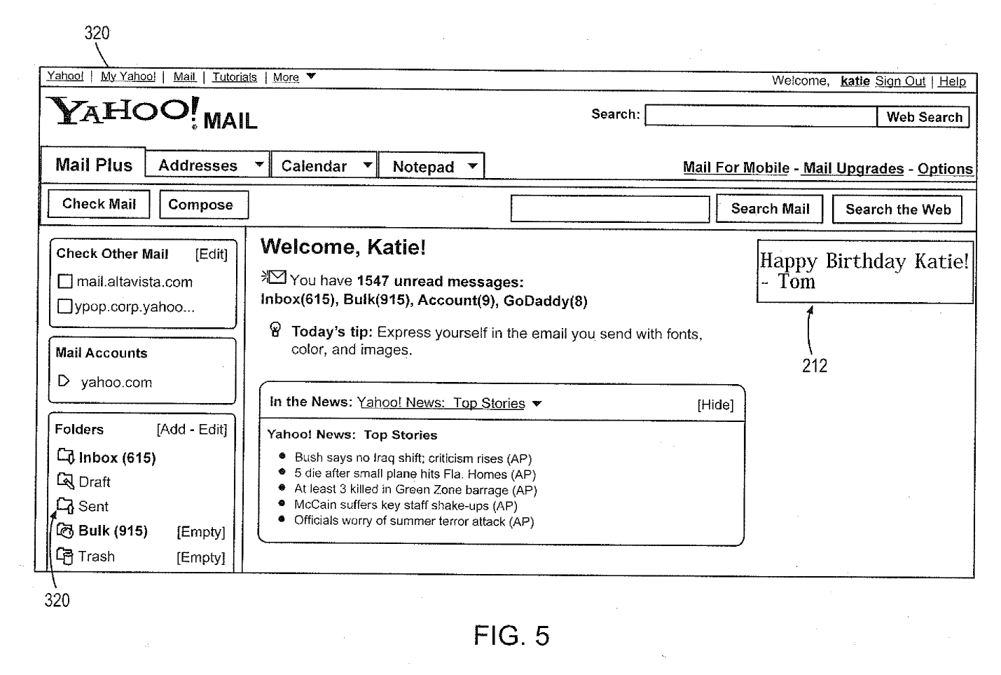

FIG. 4 is a diagram of the system 100 of FIG. 1, depicting simplified Web browser screens based on the functioning of the system 100 to provide a targeted personal (or vanity) ad in response to at least one specific user browsing to a particular Web page. FIG. 5 is a screen shot depicting an exemplary display of a personal targeted display ad in response to a specific user browsing to a predetermined website. Use of display ads for vanity ads introduces some challenges not found in displaying vanity ads in response to rare search queries. This is because, in general, display ad space used by commercial advertisers will need to be replaced with such vanity ads and rare search terms would otherwise not be monetized. As a result, marketing companies or advertising networks serving the vanity ads may need to charge more to justify such use of advertising space. Of course, many people may still be willing to pay such costs to display a vanity ad.

In a computer screen 302 of User A is depicted a similar self-serving application 204 as shown in FIG. 2, provided for submission of a display vanity ad 212, which would likely also include submission of a website uniform resource locator (URL) 314 corresponding thereto (or other information about targeted groups of users as discussed below). The website URL 314 includes any site that an advertising network of the marketing companies 1, 2 owns or with which it has a partnership relation so that the marketing company may serve the vanity ad 212 when the URL 314 is browsed to. In existing display ad products, such as in Yahoo!'s ad system, an advertiser buying display ads will normally specify where to display the ad, and include the following parameters: size and dimension; website pages and category (Sports, News, Shopping, etc.) on which the ad will be displayed; and start and end dates scheduled for display of the ad. Additionally, a user segment is indicated for targeting, including: demographic (age, gender); geographic location; behavior based on past user behavior; and time of day and day of week.

A computer screen 316 of User B includes Web browsers 320, 324 similar to those shown in FIG. 2. Here, in contrast to search-ad serving, the ad servers 130 of marketing companies detect User B browsing to a specific (or predetermined) Web page, e.g., of those saved in the Web page database 154. When the ad server 130 so detects, the browser 220, 224 of User B is re-directed to the predetermined Web page, which includes display of the vanity ad 212 previously submitted by User A to the ad server 130. The vanity ad 212 may just be uploaded into a template display for the predetermined Web page so that when User B browses to it, the vanity ad 212 is displayed therein in lieu of displaying other ads that may have been planned for that space. A couple of examples are depicted in FIG. 4.

With additional reference to FIG. 5, in the first company's browser 320 is displayed an e-mail home page 330, such as that of Google® or Yahoo!® Mail, which includes an inbox, a sent e-mail folder, a trash folder, and folders to store e-mails of friends and family. An e-mail homepage of User B is a natural choice for delivery of a personal message, and placing the vanity ad 212 where display ads normally would be seen may have a special, unexpected effect.

In the second company's browser 324 is displayed a news website that may include a particular news article 334. This news article 334 may have some special significance to User B who would have good reason to browse to or otherwise find the website. The news website may also be a website often frequented by User B and that User A would expect User B to visit regularly. Upon detecting User B browsing to the website with the news article 334, for instance, the vanity ad 212 may be displayed, to User B's surprise. In some embodiments, tracking the browsing activity of a user may be executed through use of cookies, Internet Protocol (IP) resolution, and other ways known in the art.

The above two examples are only exemplary of ways in which a vanity ad 212 may be targeted based on certain browsing behavior of User B, and additional possibilities would be endless. As in FIG. 2, the vanity ads 212 may include a hyperlink 240, that when clicked, may redirect the browser 320, 324 of User B to a more personalized message 344 or to another Web page 344 location containing a message that User A wants to convey to User B.

The User B may also include more than a single individual. In those instances, a group of users may be targeted with the help of the user target or 148, as discussed above. For instance, the User B may include a group of users, which may be explicit or implicit. More particularly, an explicit user group may include users in a blog or a news groups, e.g. in a “Vintage Watch Collectors” group or in a “Harley Davidson Riders” group. Such groups are trackable as being members of the group within the advertising network that includes the ad server 130.

An implicit group of users may include those with a certain profile, such as from a population segment including a demographic or a particular user behavior. The profile may further include a geography, a day and time, a technographic, or a network domain of users included within the implicit group. A technographic includes technical features of a user computer systems used to access and browse the Internet. Such technographic features include an operating system, a type of browser, a speed, a monitor type, etc. The User B may also include a social network of users, e.g., those that have asked questions in the “Video Games” category of Yahoo!® Answers or may include a group of users that have expressed interest in a soon-to-be-released movie. The user targetor 148 may work within or in conjunction with the ad server 130 of a marketing company to aid the ad server 130 in being as specific as possible in targeting each implicit group.

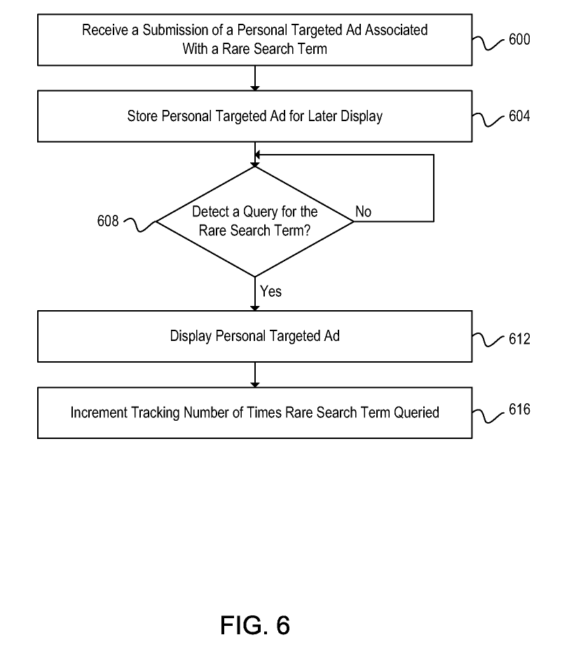

FIG. 6 is a flow chart of an exemplary method to execute the system depicted in FIGS. 1 and 2. At block 600, an ad server 130 receives, from a User A, a submission of a personal targeted ad 212 associated with at least one rare search term 214. At block 604, the ad server 130 stores the personal targeted ad 212 for later display. At block 608, the ad server 130 determines whether a query has been detected for the at least one rare search term 214. Once a query for the at least one rare search term 214 is detected, at block 608, the personal targeted ad 212 is displayed to the searching Internet user in a search results page. At block 616, the ad server 130 increments a tracking number by the number of times for which the at least one search term 214 is queried. The tracking number may then be associated with a cost-per-click (CPC) or a cost-per-action (CPA) or a cost-per-impression (CPM) in order to decrement an account of the user or charge the user for the advertising costs.

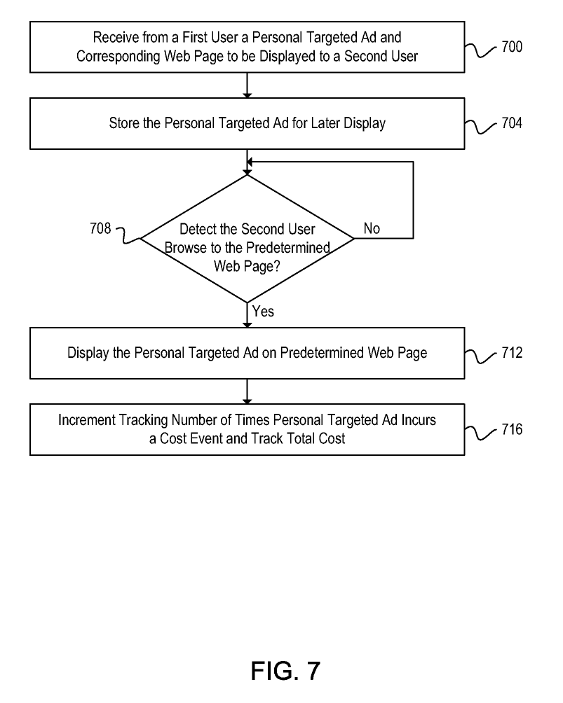

FIG. 7 is a flow chart of an exemplary method to execute the system depicted in FIGS. 1 and 3. At block 700, an ad server 130 receives, from a first user, a targeted ad 212 associated together with a corresponding predetermined Web page 314 to be displayed to a second user. At block 704, the ad server 130 stores the targeted ad 212 for later display on the predetermined Web page 314. At block 708, it is determined whether the ad server 130 has detected the second user browsing to the predetermined Web page 314. Once browsing to the predetermined Web page 314 by the second user is detected, at block 712, the ad server 130 displays on (or serves to) the predetermined Web page 314 the personal targeted ad 212. At block 716, a tracking number is incremented that tracks the number of times the personal targeted ad 212 incurs a cost event, such as an impression, an action, or a click, and the total cost of such actions in determined. Other types of cost events may also be tracked. Costs incurred by display of the personal targeted ad 212 may be passed along to the first user by a vanity ads provider 120 where the vanity ads provider 120 has submitted the personal targeted ad 212 on behalf of the first user to the ad server 130.

Various modifications, changes, and variations apparent to those of skill in the art may be made in the arrangement, operation, and details of the methods and systems disclosed. The embodiments may include various steps, which may be embodied in machine-executable instructions to be executed by a general-purpose or special-purpose computer (or other electronic device). Alternatively, the steps may be performed by hardware components that contain specific logic for performing the steps, or by any combination of hardware, software, and/or firmware. Embodiments may also be provided as a computer program product including a machine-readable medium having stored thereon instructions that may be used to program a computer (or other electronic device) to perform processes described herein. The machine-readable medium may include, but is not limited to, floppy diskettes, optical disks, CD-ROMs, DVD-ROMs, ROMs, RAMs, EPROMs, EEPROMs, magnetic or optical cards, propagation media or other type of media/machine-readable medium suitable for storing electronic instructions. For example, instructions for performing described processes may be transferred from a remote computer (e.g., a server) to a requesting computer (e.g., a client) by way of data signals embodied in a carrier wave or other propagation medium via a communication link (e.g., network connection).

1. A method for providing personal targeted advertising, the method comprising:
receiving, from a user, a submission of a search-ad comprising a personal targeted advertisement associated with at least one rare search term;
storing the personal targeted advertisement;
detecting a query for the at least one rare search term; and
displaying the personal targeted advertisement in response to the detecting of the query for the at least one rare search term.

2. The method of claim 1, wherein the submission of the personal targeted advertisement is received from a vanity ads provider, and wherein the personal targeted advertisement comprises a vanity ad.

3. The method of claim 2, further comprising:
associate a cost with the query; and
decrementing an account associated with the user by the cost of each query detected.

4. The method of claim 1, wherein displaying the personal targeted advertisement comprises displaying the personal targeted advertisement as a sponsored result.

5. The method of claim 1, wherein displaying the personal targeted advertisement comprises providing a uniform resource locator (URL) link to another Web location

6. The method of claim 5, wherein the other Web location comprises a more detailed personal message.

7. The method of claim 1, further comprising:
enabling multiple users to bid on and submit personal targeted advertisements for the at least one rare search term, wherein a ranking function is imposed to rank list the multiple user personal targeted advertisements corresponding to the at least one rare search term.

8. A method for providing personal targeted advertising, the method comprising:
receiving from a self-serving application of a vanity ads provider a submission of a personal targeted advertisement that a user desires at least one other person to see in response to at least one specific search term when queried of a search engine;
submitting the personal targeted advertisement to an advertising network of the search engine through a sponsored search account of the vanity ads provider; and
paying, on behalf of the user, any advertising fees for display of the personal targeted advertisement when queried for by the at least one other person.

9. The method of claim 8, further comprising:
displaying, by the search engine, the personal targeted advertisement at the top of, or in a sponsored result area of, the search results when the at least one specific search term is queried for by the at least one other person.

10. The method of claim 9, wherein displaying the personal targeted advertisement comprises providing a uniform resource locator (URL) link to another Web location.

11. The method of claim 10, wherein the other Web location comprises a more detailed personal message.

12. The method of claim 10, wherein paying any advertising fees comprises paying for a cost per click on the URL link by decrementing a pre-paid budget amount.

13. A method for providing personal targeted advertising, the method comprising:
receiving, from a first user, a submission of a personal targeted advertisement together with a corresponding predetermined Web page to be displayed to a second user;
storing the personal targeted advertisement for later display on the predetermined Web page;
detecting the second user browsing to the predetermined Web page; and
displaying the personal targeted advertisement on the predetermined Web page for viewing by the second user.

14. The method of claim 13, wherein the second user comprises at least one of an explicit user group and an implicit user group having a certain profile.

15. The method of claim 14, wherein the certain profile comprises at least one segment selected from the group consisting of a user demographic, a user geography, a user behavior, a day and time, a user technographic, and a network domain.

16. The method of claim 13, wherein the second user comprises a social network of users.

17. The method of claim 13, wherein the predetermined Web page comprises a Web page owned by, or that has a partnership relationship with, an advertising entity that displays the personal targeted ad.

18. The method of claim 17, wherein the predetermined Web page comprises at least one of a search engine welcome page, an e-mail welcome page, and a social networking home page.

19. The method of claim 13, wherein the submission of the personal targeted advertisement is received from a vanity ads provider on behalf of the first user, the method further comprising:
tracking a number of times the personal targeted advertisement incurs a cost event selected from the group consisting of an impression, an action, and a click; and
decrementing an account of the vanity ads provider for the total associated costs of all such cost events.

20. A system for serving personal targeted advertising, the system comprising:
an ad server including a processor, a memory, and a search results generator to serve a personal targeted advertisement in response to a user query on a rare search term, wherein the personal targeted advertisement is submitted by a customer;
a vanity ads database coupled with the ad server to store the personal targeted advertisement in relation to the rare search term; and
a Web pages database coupled with the ad server to store Web pages, or links thereto, to which the personal targeted ad is served;
wherein the processor tracks at least a number of times the rare search term is searched for so that an account of the customer may be decremented according to the cost of each search event.

21. The system of claim 20, wherein the ad server further comprises a browse detector to detect browsing by a specific user to a predetermined Web page, or link thereto, that is stored in the Web pages database, wherein upon detection, a personal targeted display advertisement submitted by the customer for the specific user is displayed on the predetermined Web page.

22. The system of claim 21, wherein the specific user comprises an explicit group of users, and wherein the cost of displaying the personal targeted display advertisement is also tracked by the processor.

23. The system of claim 20, wherein the ad server further comprises a user target or to target serving of a personal targeted display advertisement to an implicit group of users, wherein the personal targeted display advertisement is displayed on at least one Web page stored in the Web pages database that is likely to be browsed to by the implicit group of users.

24. The system of claim 23, wherein the implicit group of users is defined by a profile comprising at least one segment selected from the group consisting of a user demographic, a user geography, a user behavior, a day and time, a user technographic, and a network domain.

25. The system of claim 20, further comprising:
a vanity ads provider in network communication with a vanity ads client to receive therefrom the personal targeted advertisement together with at least one of a corresponding Web page link and a corresponding rare search term;
wherein the vanity ads provider is coupled with the ad server to submit thereto the personal targeted advertisement and corresponding at least one of the Web page link and the rare search term.
